(19) United States
(12) Patent Application Publication
(10) Pub. No.: US 2026/0089606 A1
(43) Pub. Date: Mar. 26, 2026

(54) Uplink Data Continuity During Roaming

(71) Applicant: Apple Inc., Cupertino, CA (US)

(72) Inventors: Yong Ho Seok, Cupertino, CA (US); Anuj Batra, Redwood City, CA (US); Pooya Monajemi, Sunnyvale, CA (US); Morteza Mehrnoush, Hayward, CA (US); Yong Liu, Campbell, CA (US); Jarkko L. Kneckt, Los Gatos, CA (US); Su Khiong Yong, Palo Alto, CA (US); Abdel Karim Ajami, San Jose, CA (US)

(21) Appl. No.: 19/274,205

(22) Filed: Jul. 18, 2025

Related U.S. Application Data
(60) Provisional application No. 63/697,157, filed on Sep. 20, 2024.

(51) Int. Cl. H04W 40/34; H04L 5/00; H04W 8/00

(52) U.S. Cl. CPC H04W 40/34; H04L 5/0053; H04W 8/005

(57) ABSTRACT

This disclosure relates to methods for providing uplink data continuity during roaming in a wireless local area network. A wireless device can provide a route switch request to a serving access point that initiates route switching to a target access point. The wireless device can determine that an uplink data transmission to the serving access point after the route switching is initiated is supported. The wireless device can then perform the uplink data transmission to the serving access point after the route switching is initiated.

### PRIORITY INFORMATION

This application claims priority to U.S. provisional patent application Ser. No. 63/697,157, entitled “Uplink Data Continuity During Roaming,” filed Sep. 20, 2024, which is hereby incorporated by reference in its entirety as though fully and completely set forth herein.

### TECHNICAL FIELD

The present application relates to wireless communication, including techniques and devices for providing uplink data continuity during roaming in a wireless local area network architecture.

### DESCRIPTION OF THE RELATED ART

Wireless communication systems are ubiquitous. Further, wireless communication technology has evolved from voice-only communications to also include the transmission of data, such as Internet and multimedia content.

Mobile electronic devices, or stations (STAs) or user equipment devices (UEs), can take the form of smart phones or tablets that a user typically carries. One aspect of wireless communication that can commonly be performed by mobile devices can include wireless networking, for example over a wireless local area network (WLAN), which can include devices that operate according to one or more communication standards in the IEEE 802.11 family of standards. Providing strong support for mobility, potentially including for roaming between access points in a WLAN setting, can provide significant benefits for mobile devices, but can also come with additional design challenges. Accordingly, improvements in the field are desired.

### SUMMARY

Embodiments are presented herein of, inter alia, systems, apparatuses, and methods for devices to provide uplink data continuity during roaming in a wireless local area network architecture.

A wireless device can include one or more antennas, one or more radios operably coupled to the one or more antennas, and a processor operably coupled to the one or more radios. The wireless device can be configured to establish a connection with an access point through a wireless local area network (WLAN) over one or multiple wireless links, or can be an access point configured to establish a connection with one or more other wireless devices through a WLAN over one or multiple wireless links. In some embodiments, the wireless device can operate in each of the multiple wireless links using a respective radio of the one or more radios.

According to the techniques described herein, a wireless device can determine that an uplink data transmission to a serving access point is supported after roaming to a target access point is initiated. The determination can, for example be based on an indication of whether uplink data continuity during roaming is supported for the target access point, which can be provided to the wireless device by the serving access point. The indication could be provided during pre-roaming operations, for example in discovery communications between the wireless device and the serving access point, such as in reduced neighbor report information, basic service set transition management communications, and/or multi-link probing communications. The indication could also be provided during link addition for the target access point. The determination could also or alternatively be based on a destination wireless device for the uplink data communication being associated with the serving access point, for example such that the uplink data communication can be handled locally by the serving access point without passing the distribution system.

When such uplink data continuity is supported, the wireless device can perform an uplink data transmission to a serving access point after roaming to the target access point is initiated. Such uplink data transmission can potentially occur up to and possibly even after route switching to the target access point is completed, though it may be the case that the wireless device does not transmit uplink data to both the serving access point and the target access point simultaneously. It can also be the case that the wireless device flushes uplink data from the serving access point, for example by providing a block acknowledgement request to the serving access point, before performing uplink data transmission to the target access point.

The techniques described herein can be implemented in and/or used with a number of different types of devices, including but not limited to cellular phones, tablet computers, accessory and/or wearable computing devices, portable media players, base stations, access points, and other network infrastructure equipment, servers, unmanned aerial vehicles, unmanned aerial controllers, automobiles and/or motorized vehicles, and any of various other computing devices.

This summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the present subject matter can be obtained when the following detailed description of the embodiments is considered in conjunction with the following drawings.

FIG. 1 illustrates an example wireless communication system including a wireless device, according to some embodiments;

FIG. 2 is a block diagram illustrating an example wireless device, according to some embodiments;

FIG. 3 is a block diagram illustrating an example network element or access point, according to some embodiments;

FIG. 4 is a block diagram illustrating an example modem or baseband processor, according to some embodiments;

FIG. 5 is a flowchart diagram illustrating an example method for providing uplink data continuity during roaming in a wireless local area network setting, according to some embodiments;

FIG. 6 is a signal flow diagram illustrating example aspects of a possible seamless roaming sequence, according to some embodiments;

FIG. 7 illustrates example aspects of a possible Ethernet switching-based distribution system, according to some embodiments;

FIG. 8 illustrates aspects of an example scenario in which uplink data transmission is paused during route switching, according to some embodiments;

FIG. 9 illustrates an example topology for a system with a wireless distribution system, according to some embodiments;

FIG. 10 is a signal flow diagram illustrating how route switching could proceed in the system of FIG. 9 when UL data continuity is not supported, according to some embodiments, according to some embodiments;

FIG. 11 illustrates example aspects of an information field format that could include an indicator of whether uplink data continuity during roaming is supported, according to some embodiments;

FIG. 12 is a signal flow diagram illustrating how route switching could proceed in the system of FIG. 9 when UL data continuity is supported, according to some embodiments; and

FIGS. 13-14 illustrate example aspects of another possible scenario in which uplink data continuity during roaming can be supported, according to some embodiments.

While the features described herein are susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Terminology

The following are definitions of terms used in this disclosure:
Memory Medium—Any of various types of non-transitory memory devices or storage devices. The term “memory medium” is intended to include any computer system memory or random access memory, such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The term “memory medium” can include two or more memory mediums which can reside in different locations, e.g., in different computer systems that are connected over a network. The memory medium can store program instructions (e.g., embodied as computer programs) that can be executed by one or more processors.
Carrier Medium—a memory medium as described above, as well as a physical transmission medium, such as a bus, network, and/or other physical transmission medium that conveys signals such as electrical, electromagnetic, or digital signals.
Computer System—any of various types of computing or processing systems, including a personal computer system (PC), server-based computer system, wearable computer, network appliance, Internet appliance, smartphone, television system, grid computing system, or other device or combinations of devices. In general, the term “computer system” can be broadly defined to encompass any device (or combination of devices) having at least one processor that executes instructions from a memory medium.
User Equipment (UE) (or “UE Device”)—any of various types of computer systems or devices that are mobile or portable, and that perform wireless communications. Examples of UE devices include mobile telephones or smart phones (e.g., iPhone™, Android™-based phones), tablet computers, portable gaming devices, laptops, wearable devices (e.g., smart watch, smart glasses, smart goggles, head-mounted display devices, and so forth), portable Internet devices, music players, data storage devices, or other handheld devices, automobiles and/or motor vehicles, unmanned aerial vehicles (UAVs) (e.g., drones), UAV controllers (UACs), etc. In general, the term “UE” or “UE device” can be broadly defined to encompass any electronic, computing, and/or telecommunications device (or combination of devices) which is easily transported by a user and capable of wireless communication.
Wireless Device or Station (STA)—any of various types of computer systems or devices that perform wireless communications. A wireless device can be portable (or mobile), or can be stationary or fixed at a certain location. The terms “station” and “STA” are used similarly. A UE is an example of a wireless device.
Communication Device—any of various types of computer systems or devices that perform communications, where the communications can be wired or wireless. A communication device can be portable (or mobile) or can be stationary or fixed at a certain location. A wireless device is an example of a communication device. A UE is another example of a communication device.
Base Station or Access Point (AP)—The term “Base Station” has the full breadth of its ordinary meaning, and at least includes a wireless communication station installed at a fixed location and used to communicate as part of a wireless communication system. The term “access point” (or “AP”) is typically associated with Wi-Fi-based communications and is used similarly.
Processing Element (or Processor)—refers to various elements or combinations of elements that are capable of performing a function in a device, e.g., in a communication device or in a network infrastructure device. Processors can include, for example: processors and associated memory, circuits such as an ASIC (Application Specific Integrated Circuit), portions or circuits of individual processor cores, entire processor cores, processor arrays, programmable hardware devices such as a field programmable gate array (FPGA), and/or larger portions of systems that include multiple processors, as well any of various combinations of the above.
IEEE 802.11—refers to technology based on IEEE 802.11 wireless standards such as 802.11a, 802.11b, 802.11g, 802.11n, 802.11-2012, 802.11ac, 802.11ad, 802.11ax, 802.11ay, 802.11be, and/or other IEEE 802.11 standards. IEEE 802.11 technology can also be referred to as “Wi-Fi” or “wireless local area network (WLAN)” technology.
Configured to—Various components can be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors can be configured to electrically connect a module to another module, even when the two modules are not connected). In some contexts, “configured to” can be a broad recitation of structure generally meaning “having circuitry that” performs the task or tasks during operation. As such, the component can be configured to perform the task even when the component is not currently on. In general, the circuitry that forms the structure corresponding to “configured to” can include hardware circuits.

Various components can be described as performing a task or tasks, for convenience in the description. Such descriptions should be interpreted as including the phrase “configured to.” Reciting a component that is configured to perform one or more tasks is expressly intended not to invoke 35 U.S.C. § 112 (f) interpretation for that component.

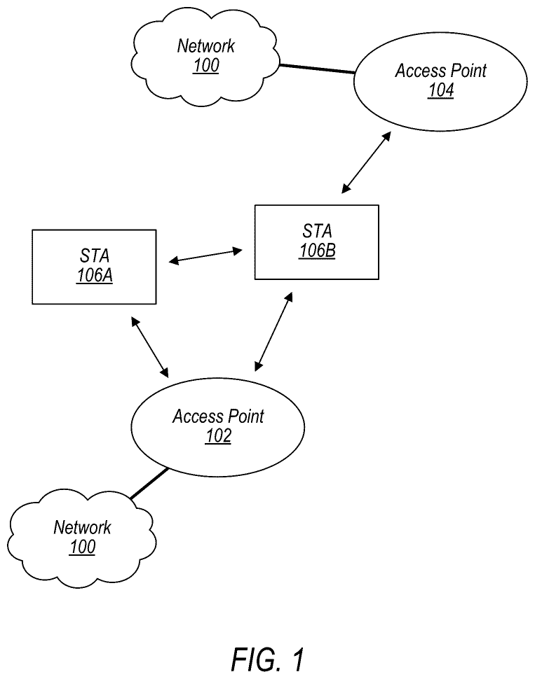

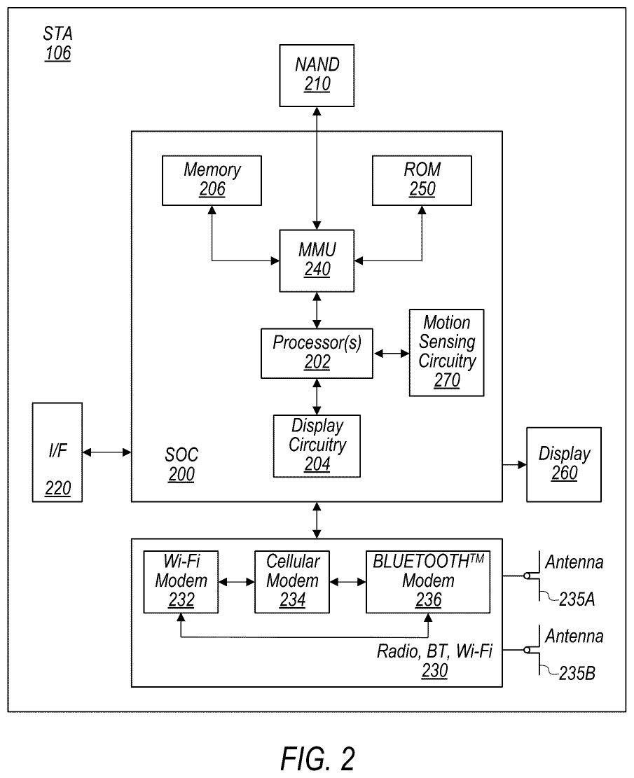

### FIGS. 1-2—Wireless Communication System

FIG. 1 illustrates an example of a wireless communication system. It is noted that FIG. 1 represents one possibility among many, and that features of the present disclosure can be implemented in any of various systems, as desired. For example, instances described herein can be implemented in any type of wireless device. The wireless communication system described below is one example.

As shown, the exemplary wireless communication system includes an access point (AP) 102, which communicates over a transmission medium with one or more wireless devices 106A, 106B, etc. Wireless devices 106A and 106B can be user devices, such as stations (STAs), non-AP STAs, UEs, or other WLAN devices.

The STA 106 can be a device with wireless network connectivity, such as a mobile phone, a hand-held device, a wearable device (e.g., such as a smart watch, smart glasses, and/or a head-mounted display device), a computer or a tablet, an unmanned aerial vehicle (UAV), an unmanned aerial controller (UAC), an automobile, or virtually any other type of wireless device. The STA 106 can include a processor (processing element) that is configured to execute program instructions stored in memory. The STA 106 can perform any of the methods described herein by executing one or more of such stored instructions. Alternatively, or in addition, the STA 106 can include a programmable hardware element, such as an FPGA (field-programmable gate array), an integrated circuit (e.g., an ASIC), a programmable logic device (PLD), and/or any of various other possible hardware components that are configured to perform (e.g., individually or in combination) any of the methods described herein, or any portion of any of the methods described herein.

The AP 102 can be a stand-alone AP or an enterprise AP, can be a base transceiver station (BTS) or cell site, and can include hardware that enables wireless communication with the STA devices 106A and 106B. The AP 102 can also be equipped to communicate with a network 100 (e.g., a core network of a service provider (e.g., a cellular service provider, an Internet service provider, and/or a carrier), a WLAN, an enterprise network, and/or another communication network connected to the Internet, among various possibilities). Thus, the AP 102 can facilitate communication among the STA devices 106 and/or between the STA devices 106 and the network 100. AP 102 can be configured to provide communications over one or more wireless technologies, such as any, any combination of, and/or all of 802.11a, b, g, n, ac, ad, ax, ay, be and/or other 802.11 versions, and/or a cellular protocol, such as 6G, 5G and/or LTE, including in an unlicensed band.

The communication area (or coverage area) of the AP 102 can be referred to as a basic service area (BSA) or cell. The AP 102 and the STAs 106 can be configured to communicate over the transmission medium using any of various radio access technologies (RATs) or wireless communication technologies, such as Wi-Fi, LTE, LTE-Advanced (LTE-A), 5G NR, 6G, ultra-wideband (UWB), etc.

AP 102 and other similar access points (not shown) operating according to one or more wireless communication technologies can thus be provided as a network, which can provide continuous or nearly continuous overlapping service to STA devices 106A-B and similar devices over a geographic area, e.g., via one or more communication technologies. A STA can roam from one AP to another AP directly, or can transition between APs and/or network cells (e.g., such as cellular network cells).

Note that at least in some instances a STA device 106 can be capable of communicating using any of multiple wireless communication technologies. For example, a STA device 106 might be configured to communicate using Wi-Fi, LTE, LTE-A, 5G NR, 6G, Bluetooth, UWB, one or more satellite systems, etc. Other combinations of wireless communication technologies (including more than two wireless communication technologies) are also possible. Likewise, in some instances a STA device 106 can be configured to communicate using only a single wireless communication technology.

As shown, the exemplary wireless communication system can also include an access point (AP) 104, which communicates over a transmission medium with the wireless device 106B. The AP 104 also provides communicative connectivity to the network 100. Thus, wireless devices can connect to either or both of AP 102 (or another cellular base station) and the access point 104 (or another access point) to access the network 100. For example, a STA can roam from AP 102 to AP 104, e.g., based on one or more factors, such as mobility, coverage, interference, and/or capabilities. Note that it can also be possible for the AP 104 to provide access to a different network (e.g., an enterprise Wi-Fi network, a home Wi-Fi network, etc.) than the network to which the AP 102 provides access.

The STAs 106A and 106B can include handheld devices such as smart phones or tablets, wearable devices such as smart watches, smart glasses, head-mountable display devices, and/or can include any of various types of devices with wireless communication capability. For example, one or more of the STAs 106A and/or 106B can be a wireless device intended for stationary or nomadic deployment, such as an appliance, measurement device/sensor, control device, etc.

The STA 106B can also be configured to communicate with the STA 106A. For example, the STA 106A and STA 106B can be capable of performing direct device-to-device (D2D) communication. Note that such direct communication between STAs can also or alternatively be referred to as peer-to-peer (P2P) communication. The direct communication can be supported by the AP 102 (e.g., the AP 102 can facilitate discovery, among various possible forms of assistance), or can be performed in a manner unsupported by the AP 102. Such P2P communication can be performed using 3GPP-based D2D communication techniques, Wi-Fi-based P2P communication techniques, UWB, BT, and/or any of various other direct communication techniques, according to various examples.

The STA 106 can include one or more devices or integrated circuits for facilitating wireless communication, potentially including a Wi-Fi modem, cellular modem, and/or one or more other wireless modems. The wireless modem(s) can include one or more processors (processor elements) and various hardware components as described herein. The STA 106 can perform any of (or any portion of) the methods described herein by executing instructions on one or more programmable processors. For example, the STA 106 can be configured to perform techniques for providing uplink data continuity during roaming in a wireless communication system, such as according to the various methods described herein. Alternatively, or in addition, the one or more processors can be one or more programmable hardware elements such as an FPGA (field-programmable gate array), application-specific integrated circuit (ASIC), or other circuitry, that is configured to perform any of the methods described herein, or any portion of any of the methods described herein. The wireless modem(s) described herein can be used in a STA device as defined herein, a wireless device as defined herein, or a communication device as defined herein. The wireless modem described herein can also be used in an AP, a base station, a pico cell, a femto cell, and/or other similar network side device.

The STA 106 can include one or more antennas for communicating using two or more wireless communication protocols or radio access technologies (RATs). In some instances, the STA device 106 can be configured to communicate using a single shared radio. The shared radio can couple to a single antenna, or can couple to multiple antennas (e.g., for MIMO) for performing wireless communications. Alternatively, the STA device 106 can include two or more radios, each of which can be configured to communicate via a respective wireless link. Other configurations are also possible.

### FIG. 2—Example Block Diagram of a STA Device

FIG. 2 illustrates an example block diagram of a STA device, such as STA 106. In some instances, the STA 106 can additionally or alternatively be referred to as a UE 106. STA 106 also can be referred to as a non-AP STA 106. As shown, the STA 106 can include a system on chip (SOC) 200, which can include one or more portions configured for various purposes. Some or all of the various illustrated components (and/or other device components not illustrated, e.g., in variations and alternative arrangements) can be “communicatively coupled” or “operatively coupled,” which terms can be taken herein to mean components that can communicate, directly or indirectly, when the device is in operation.

In some instances, the STA 106 can be configured as a Multi-Link Device (MLD). In such instances, the STA 106 (e.g., one or more radios of the STA 106) can be configured for concurrent data transmission and reception in multiple channels across a single band and/or multiple frequency bands (e.g., such as a 2.4 GHz band, a 5 GHz band, and/or a 6 GHz band). As such, the STA 106 (e.g., one or more radios of the STA 106) can be configured to perform Multi-Link Operation (MLO). For example, the STA 106 (e.g., one or more radios of the STA 106) can be configured to perform Simultaneous Transmit Receive (STR) operation (e.g., can be configured for simultaneous uplink and downlink traffic on a pair of links) and/or Enhanced Multi-Link Single-Radio (EMLSR) operation (e.g., can be configured such that a single-radio is used to listen to two or more links simultaneously).

As shown, the SOC 200 can include processor(s) 202, which can execute program instructions for the STA 106, and display circuitry 204, which can perform graphics processing and provide display signals to the display 260. The SOC 200 can also include motion sensing circuitry 270, which can detect motion of the STA 106 in one or more dimensions, for example using a gyroscope, accelerometer, and/or any of various other motion sensing components. The processor(s) 202 can also be coupled to memory management unit (MMU) 240, which can be configured to receive addresses from the processor(s) 202 and translate those addresses to locations in memory (e.g., memory 206, read only memory (ROM) 250, flash memory 210). The MMU 240 can be configured to perform memory protection and page table translation or set up. In some instances, the MMU 240 can be included as a portion of the processor(s) 202.

As shown, the SOC 200 can be coupled to various other circuits of the STA 106. For example, the STA 106 can include various types of memory (e.g., including NAND flash 210), a connector interface 220 (e.g., for coupling to a computer system, dock, charging station, etc.), the display 260, and wireless communication circuitry 230 (e.g., for LTE, LTE-A, 5G NR, 6G, Bluetooth, Wi-Fi, NFC, GPS, UWB, peer-to-peer (P2P), device-to-device (D2D), etc.).

The STA 106 can include at least one antenna, and in some instances can include multiple antennas, e.g., 235A and 235B, for performing wireless communication with access points, base stations, wireless stations, and/or other devices. For example, the STA 106 can use antennas 235A and 235B to perform the wireless communication. As noted above, the STA 106 can, in some examples, be configured to communicate wirelessly using a plurality of wireless communication standards or radio access technologies (RATs).

The wireless communication circuitry 230 can include a Wi-Fi modem 232, a cellular modem 234, and a Bluetooth modem 236. Note that one or more of the Wi-Fi modem 232, the cellular modem 234, and/or the Bluetooth modem 236 can be configured for MLO, e.g., as described above. The Wi-Fi modem 232 is for enabling the STA 106 to perform Wi-Fi or other WLAN communications, e.g., on an 802.11 network. The Bluetooth modem 236 is for enabling the STA 106 to perform Bluetooth communications. The cellular modem 234 can be capable of performing cellular communication according to one or more cellular communication technologies, e.g., in accordance with one or more 3GPP specifications.

As described herein, STA 106 can include hardware and software components for implementing aspects of this disclosure. For example, one or more components of the wireless communication circuitry 230 (e.g., Wi-Fi modem 232, cellular modem 234, BT modem 236) of the STA 106 can be configured to implement part or all of the methods for providing uplink data continuity during roaming described herein, e.g., by a processor executing program instructions stored on a memory medium (e.g., a non-transitory computer-readable memory medium), a processor configured as an FPGA (Field Programmable Gate Array), and/or using dedicated hardware components, which can include an ASIC (Application Specific Integrated Circuit).

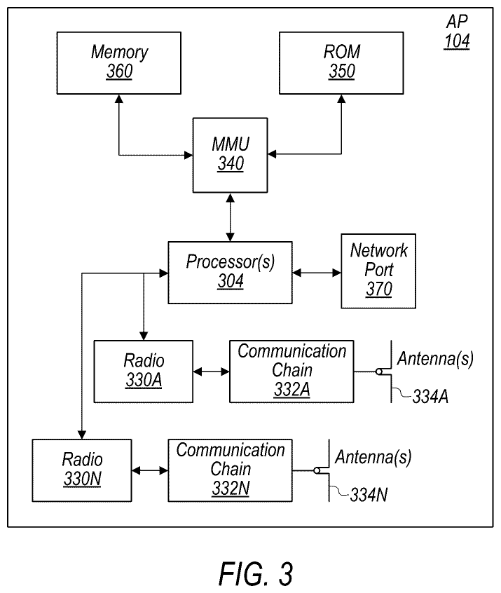

### FIG. 3—Block Diagram of an Access Point

FIG. 3 illustrates an example block diagram of an access point (AP) 104. In some instances (e.g., in an 802.11 communication context), the AP 104 can also be referred to as a station (STA), and possibly more particularly as an AP STA. It is noted that the AP of FIG. 3 is merely one example of a possible access point. As shown, AP 104 can include processor(s) 304, which can execute program instructions for the AP 104. The processor(s) 304 can also be coupled to memory management unit (MMU) 340, which can be configured to receive addresses from the processor(s) 304 and translate those addresses to locations in memory (e.g., memory 360 and read only memory (ROM) 350) or to other circuits or devices.

In some instances, the AP 104 can be configured as a Multi-Link Device (MLD). In such instances, the AP 104 (e.g., one or more radios of the AP 104) can be configured for concurrent data transmission and reception in multiple channels across a single band and/or multiple frequency bands (e.g., such as a 2.4 GHz band, a 5 GHz band, and/or a 6 GHz band). As such, the AP 104 (e.g., one or more radios of the AP 104) can be configured to perform Multi-Link Operation (MLO). For example, the AP 104 (e.g., one or more radios of the AP 104) can be configured to perform Simultaneous Transmit Receive (STR) operation (e.g., can be configured for simultaneous uplink and downlink traffic on a pair of links) and/or Enhanced Multi-Link Single-Radio (EMLSR) operation (e.g., can be configured such that a single-radio is used to listen to two or more links simultaneously).

The AP 104 can include at least one network port 370. The network port 370 can be configured to couple to a network and provide multiple devices, such as STA devices 106, with access to the network, for example as described herein above in FIG. 1.

The network port 370 (or an additional network port) can also or alternatively be configured to couple to a cellular network, e.g., a core network of a cellular service provider (e.g., a carrier and/or cellular carrier). The core network can provide mobility related services and/or other services to a plurality of devices, such as STA devices 106. In some cases, the network port 370 can couple to a telephone network via the core network, and/or the core network can provide a telephone network (e.g., among other STA devices serviced by the cellular service provider).

The AP 104 can include one or more radios 330A-330N, which can be coupled to one or more respective communication chains and at least one antenna 334, and possibly multiple antennas. The antenna(s) 334 can be configured to operate, in conjunction with one or more other components, as a wireless transceiver and can be further configured to communicate with STA devices 106 via radios 330A-330N. Note that one or more of the radios 330A-330N can be configured for MLO, e.g., as described above. The antenna(s) 334A-N communicate with one or more respective radios 330A-N via communication chains 332A-N. Communication chains 332 can be receive chains, transmit chains, or both. The radios 330A-N can be configured to communicate in accordance with various wireless communication standards, including, but not limited to, LTE, LTE-A, 5G NR, 6G, UWB, Wi-Fi, BT, etc. The AP 104 can be configured to operate on multiple wireless links using the one or more radios 330A-N. In some implementations, each radio can be used to operate on a respective wireless link.

The AP 104 can be configured to communicate wirelessly using multiple wireless communication standards. In some instances, the AP 104 can include multiple radios, which can enable the network entity to communicate according to multiple wireless communication technologies. For example, as one possibility, the AP 104 can include a 4G or 5G radio for performing communication according to a 3GPP wireless communication technology, as well as a Wi-Fi radio for performing communication according to one or more Wi-Fi specifications. In such a case, the AP 104 can be capable of operating as both a cellular base station and a Wi-Fi access point. As another possibility, the AP 104 can include a multi-mode radio that is capable of performing communications according to any of multiple wireless communication technologies (e.g., 5G NR and Wi-Fi, 5G NR and LTE, etc.). As still another possibility, the AP 104 can be configured to act exclusively as a Wi-Fi access point, e.g., without cellular communication capability.

As described further herein, the AP 104 can include hardware and software components for implementing or supporting implementation of features described herein, such as providing uplink data continuity during roaming, among various other possible features. The processor 304 of the AP 104 can be configured to implement, or support implementation of, part or all of the methods described herein, e.g., by executing program instructions stored on a memory medium (e.g., a non-transitory computer-readable memory medium) to operate multiple wireless links using multiple respective radios. Alternatively, the processor 304 can be configured as a programmable hardware element, such as an FPGA (Field Programmable Gate Array) or ASIC (Application Specific Integrated Circuit), or a combination thereof. Alternatively (or in addition) the processor 304 of the AP 104, in conjunction with one or more of the other components 330, 332, 334, 340, 350, 360, 370 can be configured to implement, or support implementation of, part or all of the features described herein.

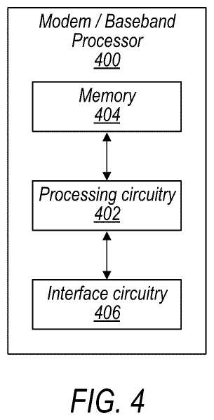

### FIG. 4—Block Diagram of a Modem or Baseband Processor

FIG. 4 illustrates an example block diagram of a modem 400, which can also be referred to as baseband processor 400. The modem 400 can provide signal processing functionality for one or more wireless communication technologies, such as Wi-Fi, Bluetooth, and/or a cellular (e.g., 3GPP) communication technology. Thus, as one possibility, modem 400 can represent a Wi-Fi modem; for example, the modem 400 illustrated in FIG. 4 can represent one possible example of Wi-Fi modem 232 illustrated in FIG. 2. As another possibility, modem 400 can represent a cellular modem or cellular baseband processor; for example, the modem 400 illustrated in FIG. 4 can represent one possible example of cellular modem 234 illustrated in FIG. 2. As a still further possibility, modem 400 can represent a Bluetooth modem; for example, the modem 400 illustrated in FIG. 4 can represent one possible example of Wi-Fi modem 236 illustrated in FIG. 2. In some instances, the modem 400 could implement functionality for supporting communication according to multiple wireless communication technologies. At least in some instances, the modem 400 can run a real-time operating system, e.g., for facilitating performance of timing-dependent wireless communication functionality.

In some instances, the modem 400 can be configured for concurrent data transmission and reception in multiple channels across a single band and/or multiple frequency bands (e.g., such as a 2.4 GHz band, a 5 GHz band, and/or a 6 GHz band). As such, the modem 400 can be configured to perform Multi-Link Operation (MLO). For example, the modem 400 can be configured to perform Simultaneous Transmit Receive (STR) operation (e.g., can be configured for simultaneous uplink and downlink traffic on a pair of links) and/or Enhanced Multi-Link Single-Radio (EMLSR) operation (e.g., can be configured such that a single-radio is used to listen to two or more links simultaneously).

The modem 400 can include processing circuitry 402, which could include one or more processor cores, ASICs, programmable hardware elements, digital signal processors, and/or other processing elements. The processing circuitry can be capable of preparing baseband signals for up-conversion and transmission by radio circuitry of a wireless device, and/or for processing baseband signals received and down-converted by radio circuitry of a wireless device. Such processing could include signal modulation, encoding, decoding, etc., among various possible functions. The processing circuitry can also or alternatively be capable of performing functionality for one or more baseband and/or other layers/sublayers of a protocol stack for the wireless communication technology (or technologies) implemented by the modem 400, such as physical layer (PHY) functionality, media access control (MAC) functionality, logical link control (LLC) functionality, radio resource control (RRC) functionality, radio link control (RLC) functionality, etc. In some instances, the modem 400 can itself include at least some radio circuitry (e.g., for performing the conversion of input baseband signals to radio frequency signals and/or of input radio frequency signals to baseband signals). Alternatively, or in addition, some or all such functions can be performed by separate radio/transceiver components of the wireless device.

The modem 400 can also include memory 404, which can include a non-transitory computer-readable memory medium. The memory 404 can include program instructions for performing signal processing and/or any of various possible general processing functions. The processing circuitry 402 can be capable of executing the program instructions stored in the memory 404. The memory 404 can also store data generated and/or used during processing performed by the processing circuitry 402.

As shown, the modem 400 can further include interface circuitry, e.g., for communicating with other components of a wireless device (such as STA 106 or AP 104 illustrated in FIGS. 1-3), such as an application processor, radio/transceiver circuitry, and/or any of various other components. Such interfaces can be implemented in any of various ways; for example, as one possibility, the modem 400 can have a direct interface with transceiver circuitry of a wireless device, and can have an additional indirect interface with an application processor and/or other components of the wireless device by way of a system bus. Other configurations are also possible.

In at least some instances, the hardware and software components of the modem 400 can be configured to implement or support implementation of features described herein, such as providing uplink data continuity during roaming, among various other possible features. For example, the processing circuitry 402 of the modem 400 can be configured to implement, or support implementation of, part or all of the methods described herein, e.g., by executing program instructions stored on memory (e.g., non-transitory computer-readable memory medium) 404 and/or using dedicated hardware components.

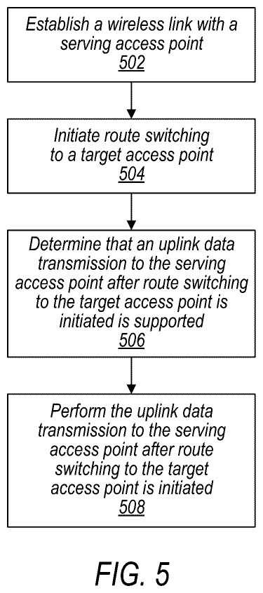

### FIG. 5—Roaming Uplink Continuity Flowchart

FIG. 5 is a flowchart diagram illustrating a method for supporting providing uplink data continuity during roaming in a WLAN setting, according to some embodiments. In various embodiments, some of the elements of the methods shown can be performed concurrently, in a different order than shown, can be substituted for by one or more other method elements, or can be omitted. Additional method elements can also be performed as desired.

Aspects of the method of FIG. 5 can be implemented by a wireless device, such as the AP 104 or STA 106 illustrated in and described with respect to FIGS. 1-4, or more generally in conjunction with any of the computer circuitry, systems, devices, elements, or components shown in the Figures, among others, as desired. For example, a processor (such as baseband processor 400 illustrated in and described with respect to FIG. 4) and/or other hardware of such a device can be configured to cause the device to perform any combination of the illustrated method elements and/or other method elements.

Note that while at least some elements of the method of FIG. 5 are described in a manner relating to the use of communication techniques and/or features associated with IEEE 802.11 specification documents, such description is not intended to be limiting to the disclosure, and aspects of the method of FIG. 5 can be used in any suitable wireless communication system, as desired. As shown, the method can operate as follows.

An access point (AP) wireless device may provide one or more basic service sets (BSSs). In some embodiments, the AP wireless device may be an AP multi-link device (MLD), which may be capable of providing a BSS on each of multiple links, such as on a 2.4 GHz link, a 5 GHz link, and/or a 6 GHz link. The AP wireless device may operate in a standalone manner or may be affiliated with one or more other devices, e.g., as part of a larger network. For example, the AP wireless device could be a member of a multi-access point (MAP) system, which could include multiple AP wireless devices, in some embodiments.

The AP wireless device may establish a wireless association with one or more non-AP (or “STA”) wireless devices (502). Such wireless associations may be established using Wi-Fi, wireless communication techniques that are based at least in part on Wi-Fi, and/or any of various other wireless communication technologies, according to various embodiments. For example, an access point (AP) wireless device may provide (e.g., broadcast) beacon transmissions including information for associating with the AP wireless device, and one or more other wireless devices (e.g., non-AP wireless devices) may request to associate with the AP wireless device using the information provided in the beacon transmissions, as one possibility. Use of (e.g., unicast) probe requests and probe responses may also be possible, in some instances, for a non-AP wireless device to obtain AP parameters and/or other system information for the AP wireless device. Variations and/or other techniques for establishing an association are also possible.

The AP wireless device may provide wireless local area network functionality to associated wireless devices, at least according to some embodiments. The AP wireless device may be considered the serving AP wireless device for associated wireless devices. As part of the wireless local area network functionality, it may be possible for wireless devices to contend for medium access and perform wireless transmissions on one or more wireless communication channels (each of which could possibly include multiple sub-channels) according to general provisions of the wireless communication technology in use by the wireless local area network (e.g., Wi-Fi, as one possibility) and/or network specific parameters configured by the AP wireless device.

For example, at least according to some embodiments, performing a downlink data transmission from the AP wireless device to a non-AP wireless device in such a wireless local area network may include contending for medium access (e.g., to avoid collisions and potential interference), and, once medium access is obtained, transmitting a physical layer (PHY) protocol data unit (PPDU) (which may also be referred to as a downlink frame) to the destination wireless device. The downlink frame may include physical layer signaling (e.g., including a preamble for frame detection, timing and frequency synchronization, channel estimation, etc., and header information indicating packet configuration, format, data rates, channel occupation time, and/or other control information) and data (which may in turn include one or more higher layer packets, such as media access control (MAC) protocol data units (MPDUs). Other types of transmissions (e.g., including triggered uplink frames, enhanced distributed channel access (EDCA) uplink frames, transmission opportunity (TXOP) sharing for peer-to-peer (P2P) communications, etc.) can also be performed in such a wireless local area network.

A wireless device that is associated with an AP wireless device can prepare for the possibility of roaming from the serving AP wireless device to another (e.g., “target”) AP wireless device. The wireless device can, for example, perform scanning operations to attempt to detect and identify other BSSs, and/or obtain information from the serving AP wireless device to attempt to detect and identify other BSSs, for example from reduced neighbor report (RNR) information that can be included in beacon transmissions by the serving AP wireless device, using BSS transition management (BTM) query/request/response frame exchanges with the serving AP wireless device, using multi-link (ML) probe request/response frame exchanges with the serving AP wireless device, etc.

In some embodiments, such a wireless device can further prepare for roaming by adding one or more links for a target AP wireless device, for example using a link addition request/response frame exchange with the serving AP wireless device. When this type of frame exchange is performed, the serving AP wireless device can provide static context transfer for the wireless device to the target AP wireless device, which can reduce route switching time if/when route switching to the target AP wireless device is performed.

The wireless device can determine to initiate route switching to a target AP wireless device. As another possibility, the serving AP wireless device can initiate route switching to a target AP wireless device for the wireless device. Determining to perform route switching for the wireless device can be based on signal strength (e.g., which could have changed due to mobility, such as if the wireless device has moved away from the serving AP wireless device and toward the target AP wireless device, and/or for any of various other possible reasons), load considerations (e.g., if the serving AP wireless device is heavily loaded and/or the target AP wireless device is lightly loaded), capability considerations (e.g., if the target AP wireless device provides one or more capabilities that the serving AP wireless device does not provide and that are prioritized by the wireless device, potentially based on a type of communication being performed by the wireless device and/or in general), and/or based on any of various other possible considerations.

The wireless device can generate and provide a route switch request to the serving AP wireless device to initiate the route switching from the serving AP wireless device to the target AP wireless device (504). Based on the route switch request, the serving AP wireless device can provide dynamic context transfer for the wireless device to the target AP wireless device. A distribution system (DS) mapping update for the wireless device can also be generated and propagated, e.g., by the target AP wireless device, to update the DS mapping for the wireless device in the DS.

The wireless device can determine that an uplink data transmission to the serving AP wireless device after route switching to the target AP wireless device has been initiated is supported, e.g., without impacting the DS mapping update for the wireless device (506). In some embodiments, uplink data continuity with the serving AP wireless device during route switching can be supported for certain types of DSs, such as at least some wireless DS (WDS) systems, potentially including those that use Wi-Fi EasyMesh. For example, in such systems, it can be the case that the DS mapping update is performed using a client association event type-length-value that is included in a topology notification frame, and that such mapping is not affected by uplink data frames. In at least some other systems (e.g., at least some Ethernet switch-based DS deployments, as one possibility), it could be the case that an uplink data transmission to the serving AP wireless device after route switching to the target AP wireless device has been initiated would impact the DS mapping update for the wireless device (e.g., could cause the DS mapping for the wireless device to revert from the target AP wireless device to the serving AP wireless device) and is thus not supported.

Accordingly, to assist the wireless device to identify whether an uplink data transmission to the serving AP wireless device after route switching to the target AP wireless device has been initiated is supported, it can be the case that the serving AP wireless device can provide an indication whether uplink data continuity after route switching is initiated is supported for the target AP wireless device. Such an indication can be provided in any number of ways. As some possibilities, such an indication can be provided in the UHR Operation element, Basic Multi-Link element of probe response, association response frame, beacon frame, or a neighbor report element of a BTM request frame. Some additional or alternative possibilities can include providing such an indication in one or more of RNR information for the target AP device, a ML probe response frame that provides information for the target AP wireless device, or a link addition response frame provided when adding a link with the target AP wireless device.

Another possible scenario in which the wireless device can potentially determine that an uplink data transmission to the serving AP wireless device after route switching to the target AP wireless device is initiated is supported could include if a destination device for the uplink data transmission is associated with the serving AP wireless device. For example, in such a scenario, it can be the case that the uplink data transmission does not reach the DS (e.g., is handled locally by the serving AP wireless device). Thus, in this case, the uplink data transmission may be supported regardless of whether uplink data continuity during roaming is supported for the target AP wireless device, at least in some embodiments.

The wireless device can generate and transmit uplink data signals (e.g., in the form of an uplink data frame) to the serving AP wireless device after route switching to the target AP wireless device is initiated (508). This uplink data transmission can be performed based at least in part on determining that the uplink data transmission to the serving AP wireless device after route switching to the target AP wireless device is initiated is supported. In some instances, multiple such uplink data transmissions to the serving AP wireless device can be performed between initiation and completion of the route switching from the serving AP wireless device to the target AP wireless device.

According to some embodiments, the wireless device can flush any remaining uplink data from the serving AP wireless device before switching the uplink data path to the target AP wireless device. For example, the wireless device can receive a route switch response from the serving AP wireless device that completes route switching to the target AP wireless device, and can generate and transmit block acknowledgement request signaling to the serving AP wireless device, which can potentially include a block acknowledgement request at least for the uplink data transmission performed after route switching to the target AP wireless device was initiated. The serving AP wireless device can in turn generate and provide a block acknowledgement frame in response, e.g., with acknowledgement information for the requested frames. This can cause the serving AP wireless device to advance its block acknowledgement scoreboard(s) for the wireless device so that the receiver (i.e., the serving AP wireless device, in this context) does not wait for any missing frames.

After the route switching is complete (and possibly after block acknowledgement request provision and reception of the corresponding block acknowledgement response frame, at least in some instances), the wireless device can generate and transmit uplink data signals (e.g., as one or more uplink data frames) to the target AP wireless device. Thus, at least according to some embodiments, it can be the case that the wireless device does not send uplink data to both the serving AP wireless device and the target AP wireless device simultaneously.

Note that at least in some embodiments, when the wireless device continues to send uplink data to the serving AP wireless device after route switching to the target AP wireless device is initiated, this can potentially cause the dynamic context information (e.g., sequence number and packet number) for the uplink data to not be synchronized between the wireless device and the target AP wireless device. Accordingly, as one approach to handle this, the sequence number and packet number can be initialized to 0 (e.g., in case the wireless device establishes different pairwise transient keys with the serving AP wireless device and the target AP wireless device), or to a predetermined or negotiated value (e.g., whether the same or different pairwise transient keys are established for the serving AP wireless device and the target AP wireless device), which can be non-continuous with and larger than the last sequence and packet number used in uplink data transmission to the serving AP wireless device.

In scenarios in which uplink data continuity with the serving AP wireless device after route switching to the target access point is initiated is not supported, it can be the case that the wireless device pauses uplink data transmissions during the route switching, and resumes uplink data transmission with the target AP wireless device only after the route switching is complete, at least according to some embodiments. This can prevent disruption to the DS mapping in systems in which the DS mapping can be affected by an uplink data transmission to the serving AP wireless device after the route switching has been initiated, but such pausing of uplink data transmission can have the potential to disrupt uplink Quality of Service.

Thus, according to the method of FIG. 5, since it can be possible to support uplink data continuity during roaming in wireless local area network settings when such uplink data continuity does not disrupt the distribution system mapping, the potential for uplink Quality of Service disruption from such roaming can be reduced, at least in some embodiments.

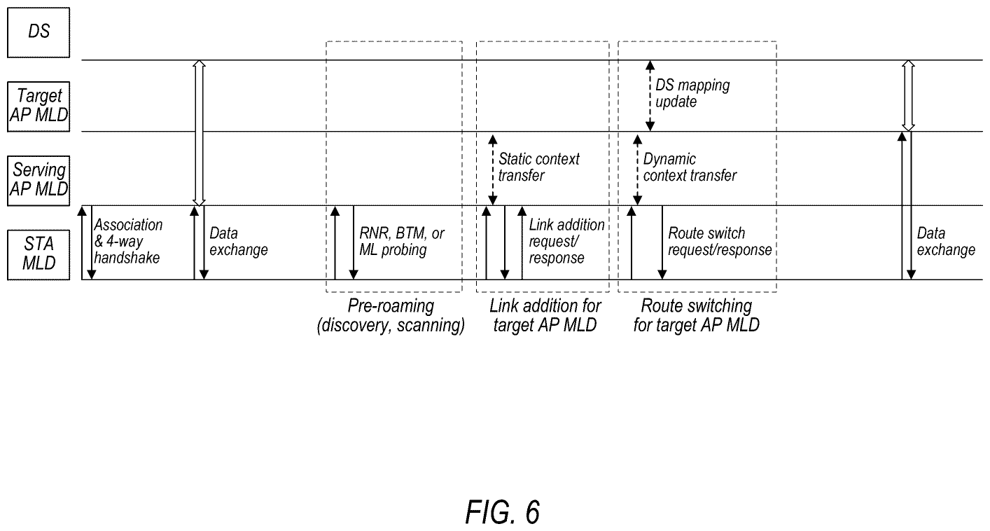

### FIGS. 6-14 and Additional Information

FIGS. 6-14 illustrate further aspects that might be used in conjunction with the method of FIG. 5. It should be noted, however, that the exemplary details illustrated in, and described with respect to, FIGS. 6-14 are not intended to be limiting to the disclosure as a whole: numerous variations and alternatives to the details provided herein below are possible and should be considered within the scope of the disclosure.

Access point facilitated roaming in a Wi-Fi based communication system, which can also sometimes be referred to as seamless roaming, can allow a wireless device to quickly transition from active association with one AP device to another AP device. FIG. 6 is a signal flow diagram illustrating example aspects of one such possible roaming sequence, according to some embodiments. As shown, a STA MLD can perform association and 4-way handshake with a serving AP MLD. The STA MLD and the serving AP MLD can perform data exchange, potentially including exchange of data that is received into and/or sent out of the distribution system (DS) for the serving AP MLD and the STA MLD.

The STA MLD and the serving AP MLD can perform pre-roaming activity, which can include scanning and/or performing discovery of neighbor AP devices via reduced neighbor report (RNR), basic service set transition management (BTM), and/or multi-link (ML) probing messages, among various possibilities. These activities can help the STA MLD prepare for the possibility that roaming to a neighbor AP device is advantageous, e.g., due to mobility, congestion, wireless medium condition changes, and/or for any other reason, for example by obtaining signal strength information, capability information, and/or other types of information for neighbor AP devices.

To further prepare for possible roaming, the STA MLD can exchange link addition request and response messages to add a link with a target AP MLD. The serving AP MLD can provide static context transfer (e.g., MAC and PHY capability information, etc.) for the STA MLD to the target AP MLD.

Once a decision to roam to the target AP MLD has been made, the STA MLD and the serving AP MLD can exchange route switch request and response messages to accomplish the STA's roaming from the serving AP MLD to the target AP MLD. The serving AP MLD can provide dynamic context transfer (e.g., sequence number information, packet number information, etc.) for the STA MLD to the target AP MLD. The target AP MLD can also provide a DS mapping update to the entity providing DS functionality. After the route switching, the STA MLD and the target AP MLD can perform data exchange, potentially including exchange of data that is received into and/or sent out of the DS.

Splitting the link addition and route switching aspects of roaming, such as is performed in the example scenario of FIG. 6, can reduce the time to perform the route switching, which can potentially improve uplink Quality of Service (QoS), at least according to some embodiments.

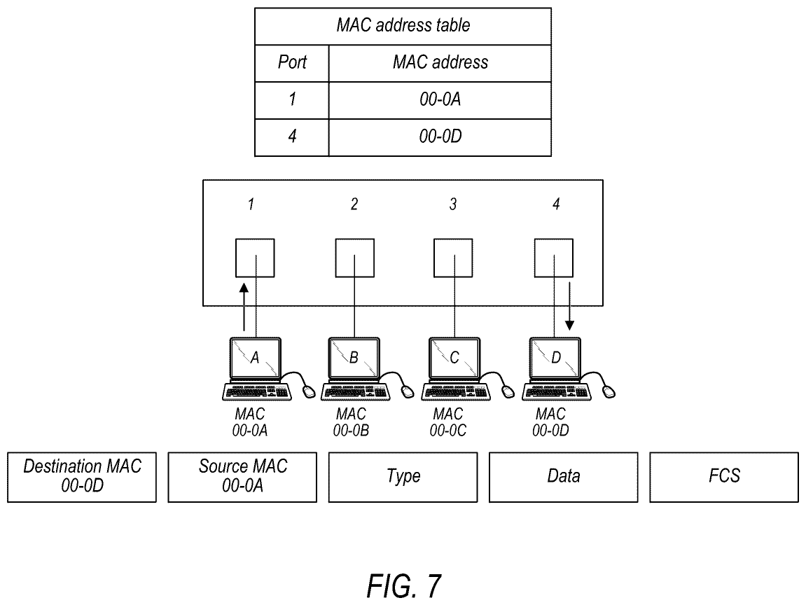

There can be multiple types of distribution systems. As one example, an Ethernet switching-based system can be used. FIG. 7 illustrates example aspects of one such possible system, according to some embodiments. In the illustrated system, a “backwards learning” approach can be used to determine how to distribute frames. This can include use of a MAC address table, which is populated (and refreshed) based on frames received from devices in the system. In the example scenario illustrated in FIG. 7, the switch receives a frame from PC-A and refreshes the timer for the MAC address entry associated with port 1, and as the switch has a recent entry for the destination MAC address, the switch can filter the frame to forward it only out of port 4.

As another example, a wireless distribution system (WDS), which could be based on Wi-Fi EasyMesh and/or one or more other technologies, can be used.

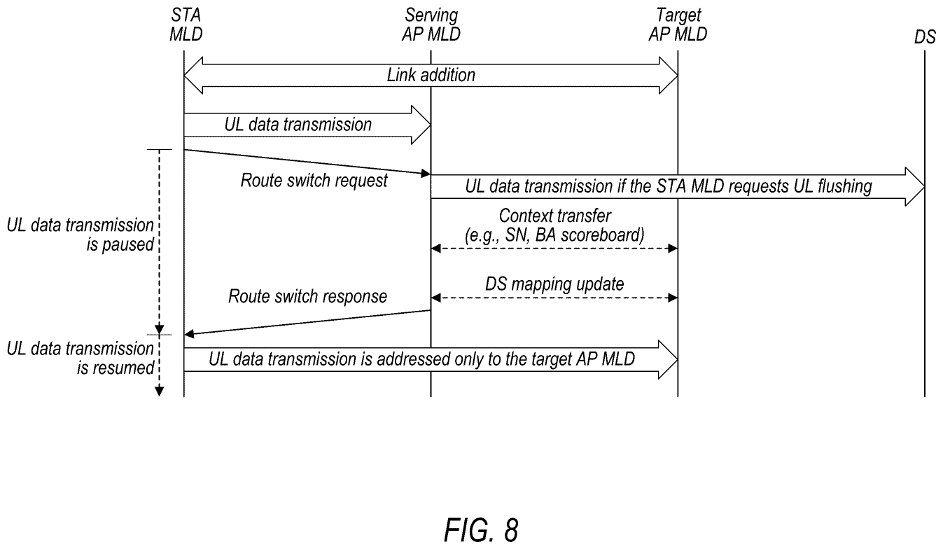

After initiating a route switch over DS for a STA MLD from a serving AP MLD to a target AP MLD, it can be the case that the STA MLD pauses UL data transmission (e.g., does not send any further UL data to the serving AP MLD) until the route switch is complete. For example, depending on the DS implementation (e.g., in case of Ethernet switching), such UL data transmission could cause an unexpected route switch over DS from the target AP MLD back to the serving AP MLD, so the STA MLD (e.g., which may be unaware of the type of DS used) may be configured to not send UL data to the serving AP MLD after providing a route switch request. FIG. 8 illustrates aspects of an example scenario in which this approach is used, according to some embodiments.

However, the amount of time to perform a route switch can vary, e.g., depending on the DS. For example, a residential network using WDS (e.g., based on Wi-Fi EasyMesh) could require multiple multi-hop transmissions to complete a route switch, which could take on the order of tens of milliseconds, in some embodiments. In WDS, it can be the case that all control messages for route switching and DS mapping are encapsulated within a data frame. For example, in Wi-Fi EasyMesh, the 1905.1 network protocol can be used for controlling the mesh, and the EtherType 0x893a can be allocated for encapsulating Control Message Data Units (CMDUs). This can mean that all buffered UL/DL data packets need to be delivered first in order to deliver route switching and DS mapping messages to the next hop, which can cause a latency increase. As the route switch time increases, the disruption to the UL QoS can worsen accordingly when UL data transmission to the serving AP MLD is disallowed during the route switch.

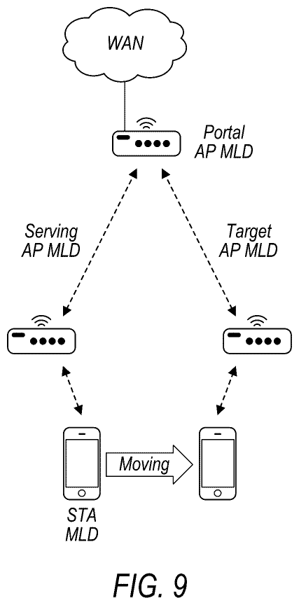

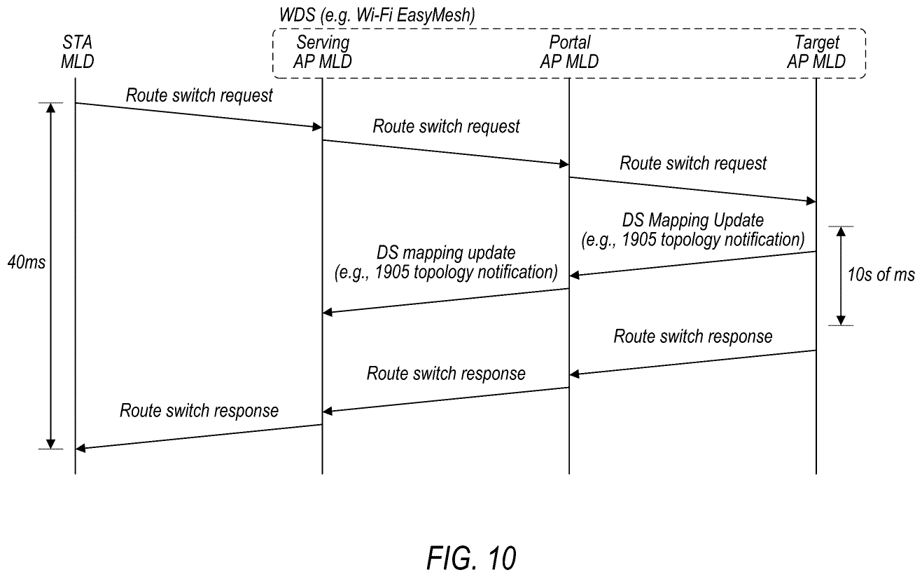

FIG. 9 illustrates an example topology for a system with WDS, in which a STA MLD can roam from a serving AP MLD to a target AP MLD. FIG. 10 is a signal flow diagram illustrating how route switching could proceed in such a system. As shown, in the illustrated example, a total of 8 transmissions are performed to accomplish the route switch over the WDS. For a total channel access and queueing delay of 5 ms, the corresponding route switching time is thus approximately 40 ms in the illustrated example. It should be noted that this example is meant to be illustrative and not limiting, and that numerous other arrangements, potentially with different topologies and/or route switching times, are also possible.

Since it may be the case that WDS does not use backward learning for the DS mapping update (e.g., Wi-Fi EasyMesh can use the IEEE 1905.1 Topology Notification for DS mapping functionality, as previously described herein), it can be the case that UL data continuity can be supported in such a system without impacting the DS mapping, at least according to some embodiments. Providing support for UL data continuity during route switching when the DS mapping would be unaffected by the UL data continuity can accordingly help mitigate the potential for UL QoS degradation during route switching, at least in some instances.

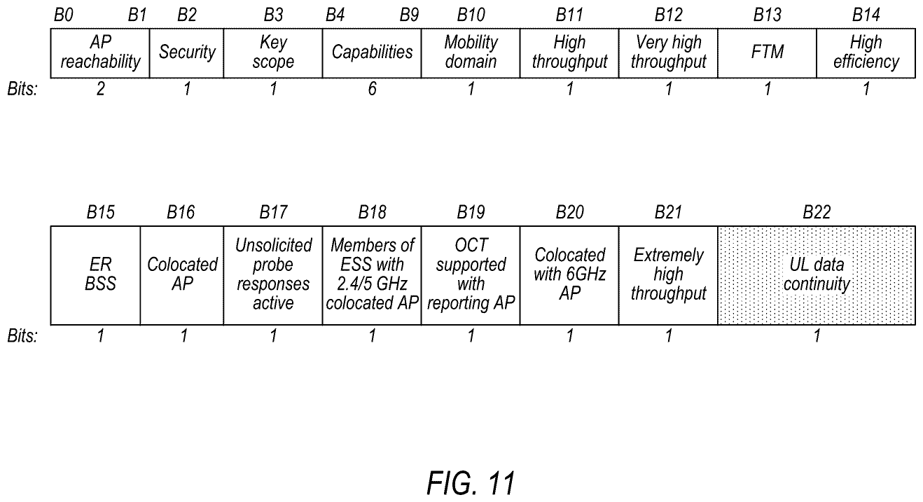

To provide such support, it can be the case that the serving AP MLD indicates whether UL data continuity is supported while the STA MLD is performing the roaming sequence to the target AP MLD. For example, when the serving AP MLD provides the target AP MLD information through the BTM request frame, the Neighbor Report element for the target AP MLD can include a field or subfield to indicate whether UL Data continuity for the target AP MLD is set to ‘true’ or ‘false’. FIG. 11 illustrates example aspects of a BSSID information field format that could include such an indicator, according to some embodiments. Note that such an indication could also or alternatively be provided in any number of other ways, potentially including using other field/subfield formats, and/or in other signaling (e.g., RNR, ML probe response, link addition response, etc.).

When UL data continuity support is indicated, until the route switch is completed, it can be the case that the STA MLD can continue sending UL data to the serving AP MLD. After the route switch is completed, the STA MLD can switch the UL data path from the serving AP MLD to the target AP MLD. In some instances, the exact timing of the UL data path switch can be left to the STA's implementation. It may be the case that to ensure in-order delivery of the UL data, the STA MLD does not send UL data to both the serving AP MLD and the target AP MLD simultaneously. Additionally, at least in some instances, before switching the UL data path, the STA MLD can flush the UL data by sending a Block Acknowledgement (BA) request to the serving AP MLD, e.g., to advance the BA scoreboard so that the receiver (i.e., the serving AP MLD) does not wait for any missing packets.

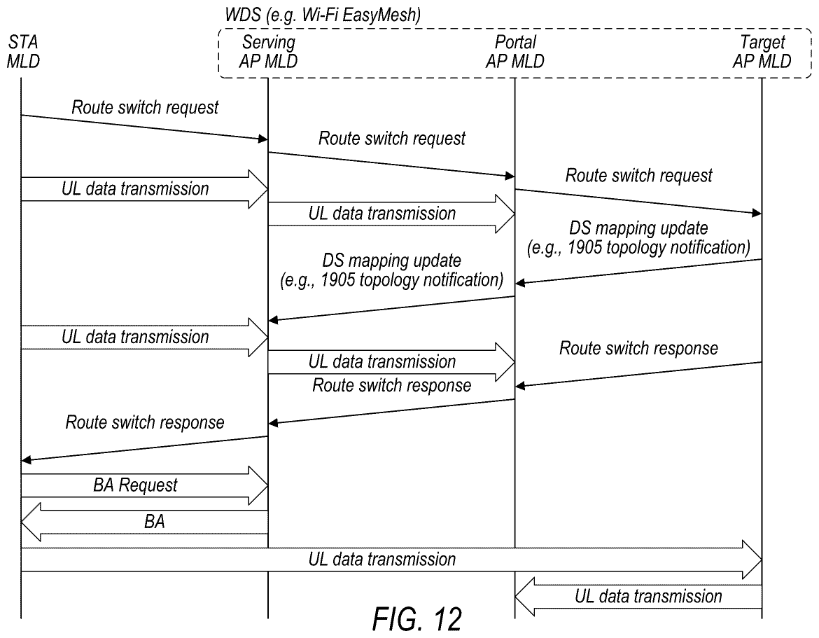

FIG. 12 is a signal flow diagram illustrating how route switching could proceed in the system of FIG. 9 when UL data continuity is supported. As shown, UL data transmissions to the serving AP MLD can be performed after the route switch request is transmitted and before the route switch response is received. After the route switch response is received by the STA MLD to complete the route switch, the STA MLD can send a BA request to the serving AP MLD to flush any UL data and switch the UL data path to the target AP MLD.

Note that since in this scenario, during route switching, the STA MLD continues to send UL data to the serving AP MLD, it can be the case that at least some of the dynamic context information (e.g., the sequence number and packet number information) for the UL data is not synchronized between the STA MLD and the target AP MLD. Accordingly, in some embodiments, it can be the case that the sequence number and packet number are initialized to 0 for UL data addressed to the target AP MLD. Provided the STA MLD establishes different pairwise transient keys (PTKs) with the serving AP MLD and the target AP MLD, it can be the case that initializing the packet number in this way does not cause any security issues. As another possibility (e.g., if the same PTK is used after roaming), it can be the case that predetermined or negotiated (e.g., non-continuous and larger) numbers can be used for UL data addressed to the target AP MLD after the route switch.

Thus, since it can be the case that a WDS does not use backward learning for DS mapping updates, it may be possible to support UL data continuity during a seamless roaming sequence, such that disallowing UL data transmission regardless of DS capability after initiating a route switch may be unnecessary. Accordingly, in some embodiments, if the DS can support UL data continuity after initiating a route switch, the serving AP MLD can indicate that UL data continuity is supported, which can help reduce the potential for UL QoS degradation during route switching.

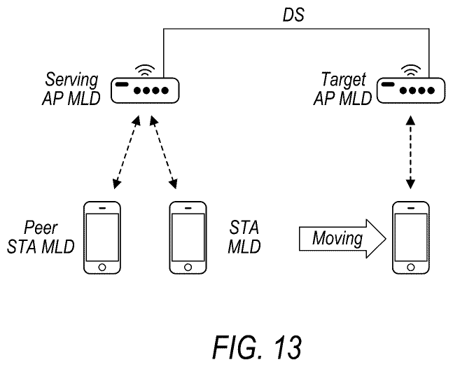

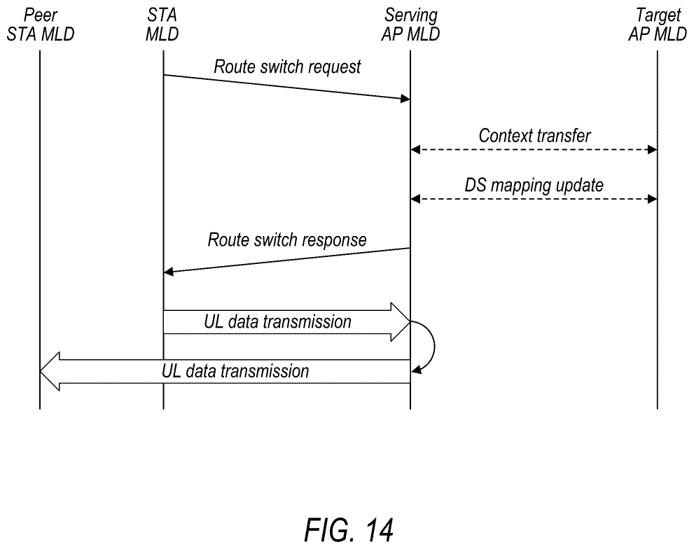

Note that in some embodiments, similar techniques can also be used for tunneled direct link setup (TDLS) scenarios and/or other peer communication scenarios, at least in some embodiments. FIG. 13 illustrates example aspects of a system in which such a scenario could occur. As shown, in the illustrated scenario, a STA MLD can communicate with a peer STA MLD via a serving AP MLD. The STA MLD is moving to a target AP MLD. FIG. 14 is a signal flow diagram illustrating example aspects of how such signaling and data communication could be performed, according to some embodiments. As shown, since the uplink data is not passing the DS in this scenario, the STA MLD can continue to send uplink data to the peer STA associated with the same AP MLD, even after initiating a route switch request to move to the target AP MLD. In other words, in some scenarios, depending on the destination of the uplink data, it can be the case that a STA can send uplink data after initiating a route switch in any type of DS, at least according to some embodiments. In order to determine that the frame destined for a peer STA is not passing the DS, the AP MLD can indicate whether the serving AP MLD supports uplink data continuity for that peer STA.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

In addition to the above-described exemplary embodiments, further embodiments of the present disclosure can be realized in any of various forms. For example, some embodiments can be realized as a computer-implemented method, a computer-readable memory medium, or a computer system. Other embodiments can be realized using one or more custom-designed hardware devices such as ASICs. Still other embodiments can be realized using one or more programmable hardware elements such as FPGAs.

In some embodiments, a non-transitory computer-readable memory medium can be configured so that it stores program instructions and/or data, where the program instructions, if executed by a computer system, cause the computer system to perform a method, e.g., any of the method embodiments described herein, or, any combination of the method embodiments described herein, or, any subset of any of the method embodiments described herein, or, any combination of such subsets.

In some embodiments, a device (e.g., an AP 104 or a STA 106) can be configured to include a processor (or a set of processors) and a memory medium, where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device can be realized in any of various forms.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method for operation in wireless communication, comprising:
initiating route switching from a serving access point (AP) device to a target AP device;
determining, after route switching to the target AP device is initiated, that an uplink data transmission to the serving AP device is supported; and
performing, based at least on determining the uplink data transmission to the serving AP device is supported, the uplink data transmission to the serving AP device after route switching to the target AP device is initiated.

2. The method of claim 1, wherein the method further comprises:
receiving an indication that uplink data continuity after route switching is initiated is supported for the target AP device,
wherein determining that the uplink data transmission after route switching to the target AP device is initiated is supported is based at least in part on the indication that uplink data continuity after route switching is initiated is supported for the target AP device.

3. The method of claim 2,
wherein the indication that uplink data continuity after route switching is initiated is supported for the target AP device is received in a neighbor report element of a basic service set transition management (BTM) request frame.

4. The method of claim 2,
wherein the indication that uplink data continuity after route switching is initiated is supported for the target AP device is received in at least one of:
reduced neighbor report (RNR) information;
a multi-link (ML) probe response frame; or
a link addition response frame.

5. The method of claim 1, wherein the method further comprises:
receiving, from the serving AP device, a route switch response that completes route switching to the target AP device; and
providing, to the serving AP device, after receiving the route switch response, a block acknowledgement request for the uplink data transmission performed.

6. The method of claim 5, wherein the method further comprises:
performing an uplink data transmission to the target AP device after providing the block acknowledgement request to the serving AP device,
wherein at least one of sequence number or packet number information for the uplink data transmission to the target AP device is initialized at 0 or at a predetermined or negotiated value.

7. The method of claim 1,
wherein a destination device for the uplink data transmission is associated with the serving AP device, and
wherein determining that the uplink data transmission after route switching to the target AP device is initiated is supported is based at least in part on the destination device for the uplink data transmission being associated with the serving AP device.

8. A processor, comprising memory configured to cause the processor to perform operations comprising:
receiving, from a serving access point (AP) device, an indication that uplink data continuity after route switching is initiated is supported for a target AP device;
generating a route switch request configured to initiate route switching to the target AP device; and
generating one or more uplink data signals configured for transmission to the serving AP device after route switching to the target AP device is initiated, based at least in part on the indication that uplink data continuity after route switching is initiated is supported for the target AP device.

9. The processor of claim 8,
wherein the indication that uplink data continuity after route switching is initiated is supported for the target AP device is received in a neighbor report element of a basic service set transition management (BTM) request frame.

10. The processor of claim 8,
wherein the indication that uplink data continuity after route switching is initiated is supported for the target AP device is received in reduced neighbor report (RNR) information.

11. The processor of claim 8,
wherein the indication that uplink data continuity after route switching is initiated is supported for the target AP device is received in a multi-link (ML) probe response frame.

12. The processor of claim 8,
wherein the indication that uplink data continuity after route switching is initiated is supported for the target AP device is received in a link addition response frame.

13. The processor of claim 8, wherein the memory is further configured to cause the processor to perform operations comprising:
receiving, from the serving AP device, a route switch response that completes route switching to the target AP device;
generating block acknowledgement request signaling configured for provision to the serving AP device after receiving the route switch response; and
generating uplink data signals configured for transmission to the target AP device after the block acknowledgement request is provided to the serving AP device.

14. An access point (AP) wireless device, comprising:
one or more antennas;
one or more radios operably coupled to the one or more antennas; and
a processor operably coupled to the one or more radios;
wherein the AP wireless device is configured to:
transmit, to a non-AP device, an indication that uplink data continuity after route switching is initiated is supported for a target AP device;
receive, from the non-AP device, a route switch request to initiate route switching for the non-AP device to the target AP device; and
receive uplink data, from the non-AP device, after route switching is initiated for the non-AP device to the target AP device.

15. The AP wireless device of claim 14,
wherein the indication that uplink data continuity after route switching is initiated is supported for the target AP device is comprised in a basic service set transition management (BTM) request frame.

16. The AP wireless device of claim 15,
wherein the indication that uplink data continuity after route switching is initiated is supported for the target AP device is comprised in a neighbor report element of the BTM request frame.

17. The AP wireless device of claim 14,
wherein the indication that uplink data continuity after route switching is initiated is supported for the target AP device is comprised in reduced neighbor report (RNR) information.

18. The AP wireless device of claim 14,
wherein the indication that uplink data continuity after route switching is initiated is supported for the target AP device is comprised in a multi-link (ML) probe response frame.

19. The AP wireless device of claim 14,
wherein the indication that uplink data continuity after route switching is initiated is supported for the target AP device is comprised in a link addition response frame.

20. The AP wireless device of claim 14, wherein the AP wireless device is further configured to:
transmit, to the non-AP device, a route switch response that completes route switching to the target AP device;
receive, from the non-AP device, after the route switch response is transmitted, a block acknowledgement request; and
transmit, to the non-AP device, a block acknowledgement that includes acknowledgement information for the uplink data received from the non-AP device after initiation of route switching for the non-AP device to the target AP device.
